(19) United States
(12) Patent Application Publication
(10) Pub. No.: US 2025/0027754 A1
(43) Pub. Date: Jan. 23, 2025

(54) Target Chassis and Targets Incorporating the Chassis

(71) Applicant: Marathon Robotics Pty Ltd, Eveleigh (AU)

(72) Inventors: Alex Makarenko, Eveleigh (AU); Andrew Handmer, Eveleigh (AU)

(21) Appl. No.: 18/712,555

(22) PCT Filed: Nov. 28, 2021
(86) PCT No.: PCT/AU2021/051419

§ 371 Date: May 22, 2024

(51) Int. Cl. F41J 9/02; B60G 11/00; B60G 13/00; B60K 1/02; B62D 7/08; F41H 7/00; F41J 2/00; F41J 5/06

(52) U.S. Cl. CPC F41J 9/02; B60G 11/00; B60G 13/00; B60K 1/02; B62D 7/08; F41H 7/005; F41J 2/00; F41J 5/06

(57) ABSTRACT

A target chassis for a target for use in training personnel in engaging vehicles with munitions include a front armored enclosure, a rear armored enclosure which is spaced away from the front armored enclosure, a set of front wheels associated with the front armored enclosure, and a set of rear wheels associated with the rear armored enclosure.

### TECHNICAL FIELD

The present invention relates to targets for use in training personnel in the use of firearms and other munitions. The invention particularly relates to a chassis for use in a mobile target that allows practice of engaging vehicles with various types of weaponry.

### BACKGROUND OF RELATED ART

Various prior attempts have been made to provide targets which allow for practicing engaging vehicles with weaponry.

Stationary two-dimensional (2D) vehicle targets which are shaped to have the silhouette of a vehicle can be placed on a range with some type of lifter or pop-up mechanism to allow the target to be presented to shooters. Rail based or towed 2D targets provide a more realistic experience because rather than “popping up” the target can be moved across a range in a more realistic simulation of the movement of a vehicle. However, all two-dimensional targets suffer from the limitation that they can only be viewed side on.

It has been tried to provide three dimensional targets which travel across the ground on wheels. One approach has been to prepare a target which will be intentionally destroyed in the training exercise. In one approach a car is fitted with a “robotic applique kit”, which consists of a computer and a set of actuators which can be retro-fitted to a real vehicle to make it computer-controlled (GPS-guided). However, the resulting vehicle is not armored in any way and is designed to be damaged or destroyed and thereby sacrificed in a munitions training exercise.

Approaches to reusable three-dimensional (3D) targets involve covering the target with armor plating. However, for a vehicle sized target, the required armor plating to protect the target will typically result in a vehicle which weighs more than 5 tones. The resulting target will generally have the outer appearance and movement characteristic of an armored vehicle, will be very expensive to produce and maintain, and will have very high energy requirements to move about a firing range.

There remains a need for improved targets for use in practicing engagement of vehicles with firearms and other munitions.

### SUMMARY

In a first aspect the present invention provides a target chassis for a target for use in training personnel in engaging vehicles with munitions including: a front armored enclosure; a rear armored enclosure which is spaced away from the front armored enclosure; a set of front wheels is associated with the front armored enclosure, and a set of rear wheels is associated with the rear armored enclosure.

The armored enclosures may be maintained in a fixed spaced apart relationship by way of an arrangement of beams.

The arrangement of beams may include two hollow cylindrical beams.

The chassis may further include a set of rear suspension springs which are associated with the rear wheels, and the rear suspension springs are located inside the rear armored enclosure.

The chassis may further include a set of rear dampers which are associated with the rear wheels, and the rear dampers are located inside the rear armored enclosure.

The chassis may further include a set of front suspension springs which are associated with the front wheels, and the front suspension springs are located inside the front armored enclosure.

The chassis may further include a set of front dampers which are associated with the front wheels, and the front dampers are located inside the front armored enclosure.

The rear wheels may be driven.

The front wheels may be driven.

The chassis may further include one or more electric motors to drive at least two of the wheels of the chassis.

An electric motor may be associated with each driven wheel.

The motors may be located inside the armored enclosure with which the driven wheels are associated.

The chassis may include a battery pack which is located in the rear armored enclosure.

The chassis may include a battery pack which is located in the front armored enclosure.

The chassis may further include a steering mechanism to enable the target to be steered.

The steering mechanism may be an Ackermann steering mechanism.

In a second aspect the present invention provides a target including: a chassis according to any preceding claim; and a target body mounted to the chassis, the target body having an outer appearance to simulate the appearance of a motor vehicle.

The target body may include at least one representation of an occupant of the vehicle.

The target may further include at least one bullet detection system.

The at least one bullet detection system may be arranged to detect bullets striking the at least one representation of an occupant.

The at least one bullet detection system may be arranged to detect a hit in the region of the expected location of the engine of the simulated vehicle.

The at least one bullet detection system may be arranged to detect near misses of either the representations of the occupants or the expected location of the engine of the simulated vehicle.

The target may further include at least one heating device to simulate a thermal signature of a motor vehicle.

### BRIEF DESCRIPTION OF THE DRAWINGS

An embodiment of the present invention will now be described, by way of example only, with reference to the accompanying drawings, in which:

FIG. 1 is a perspective view of a target chassis;

FIG. 2A is a view of the front armored enclosure of the chassis of FIG. 1 with top cover removed;

FIG. 2B is a view of the rear armored enclosure of the chassis of FIG. 1 with top cover removed;

FIG. 3 shows the chassis of FIG. 1 incorporated into a target which represents a motor vehicle;

FIG. 4 shows the chassis of FIG. 1 in another target configuration; and

FIG. 5 shows the chassis of FIG. 1 in another target configuration.

### DETAILED DESCRIPTION

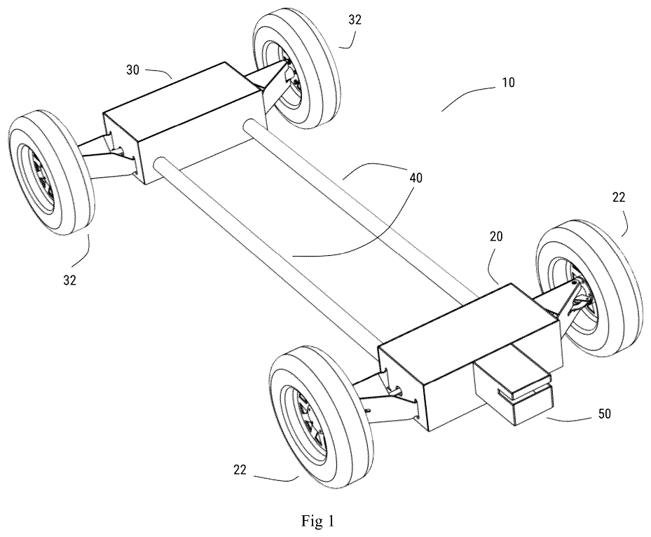

Referring to FIG. 1, a target chassis 10 is shown for use in training personnel in engaging vehicles with munitions. The chassis includes a front armored enclosure 20 and a rear armored enclosure 30 which is spaced away from the front armored enclosure 20 by way of an arrangement of two hollow cylindrical beams in the form of hardened steel tubes 40. A set of two front wheels 22 is associated with the front armored enclosure 20, and a set of two rear wheels 32 is associated with the rear armored enclosure 30.

The chassis is an autonomous Ackermann-steered electrically-propelled vehicle. The vehicle navigates using similar sensors and software to those described in applicant's international patent publication WO2011/035363. A laser rangefinder (not visible) is housed inside metal housing 50 which is attached to the front enclosure 20. A horizontally oriented slot (not visible) is provided in the housing. In use the laser rangefinder scans ahead of the front of the vehicle by emitting a scanning laser beam through the slot.

The working parts of the chassis are packed as densely as possible into the two armored enclosures: the front enclosure houses the steering and front suspension and some ancillaries including fans for active cooling; The rear enclosure contains the drive-motors, rear suspension, computer, batteries, emergency brakes, etc.; The steel tubes 40 provide the structure and are used to pass electric cables between the front and rear enclosures.

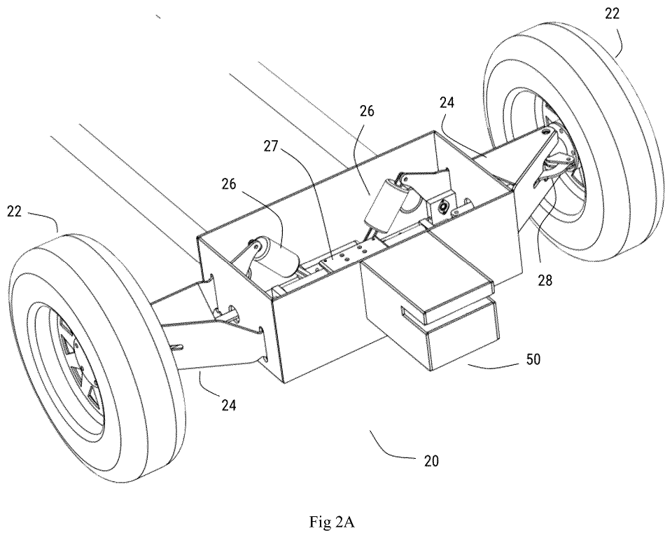

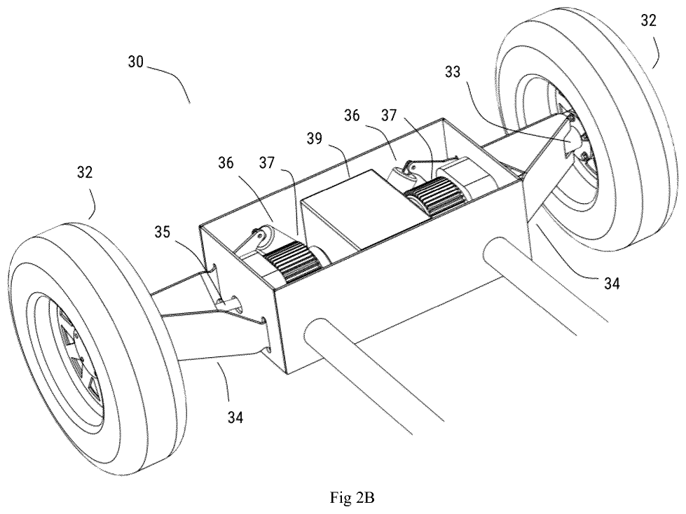

Referring to FIG. 2A, the front armored enclosure 20 is shown with top cover removed. The front wheels 22 are connected to the front enclosure 20 by way of a pair of suspension arms 24. The arms are pivotally connected to the enclosure 20 at their inboard ends and are connected to combined suspension spring and shock absorbers 26 which control the rotational generally upward and downward movement of the outboard ends of the suspension arms.

The wheels 22 are mounted to hubs which are pivotally connected to the outboard ends of the suspension arms. The hubs form part of an Ackermann type steering mechanism whereby steering arms 28 are moved by steering mechanism 27 to pivot the hubs to steer the target chassis in use.

All of the top, bottom and side panels of the armored enclosure 20, the suspension arms, and the steering arms are formed from hardened steel plate material. The suspension arms 24 are fabricated into a box type structure formed by welding together pieces of plate. The steering arms 28 are also formed from flat cut-out shapes. The steering arms 28 are horizontally orientated in the steering mechanism. This means that they present a small area towards the direction from which they may be struck by bullets in use, and if they are struck, they are struck from a direction generally lying in the plane of the plate and they thereby exhibit high stiffness to resist becoming deformed.

Referring to FIG. 2B, the rear armored enclosure 30 is somewhat similar to the front enclosure but does not include a steering mechanism. Rear wheels 32 are mounted on suspension arms 34 which are pivotally attached to the rear enclosure and are controlled by combined suspension spring and dampers 36 mounted inside the enclosure 30. The wheels 32 are mounted on hubs 33 (one visible) which are attached to the ends of shafts 35 (one visible). The shafts 35 are each connected to electric motors 37 which drive the rear wheels and which are housed in the rear enclosure 30. The rear enclosure also houses a battery pack 39 to power the motors.

Either or both of the front and rear enclosures houses other electronic systems required to operate the chassis as part of a target in a target training exercise including: Communications systems; Location detection systems in the form of a GPS receiver; Collision avoidance systems and sensors; On board control computer; Systems for controlling headlights and taillights; Thermal signature system; Sound effects; and Hit sensing.

The chassis is intended for use in live fire training using hand-held firearms. The chassis is to be incorporated into a target and then moves about in a training area as part of a training exercise. In use, the chassis will be struck by bullets. The wheels of the chassis 22, 32 are fitted with solid tires that therefore cannot be punctured by bullets. The front and rear armored enclosures protect the components and systems mounted in the enclosures from being damaged by bullets. By providing front and rear enclosures, the armored volume of the chassis is kept to a minimum. This means that the weight of the armor required is also kept to a minimum. This in turn leads to weight savings for the vehicle which in turn means that the adequate acceleration and performance characteristics of the vehicle can be achieved using the smallest possible electric motors, and that the life of the on-board battery pack is maximized.

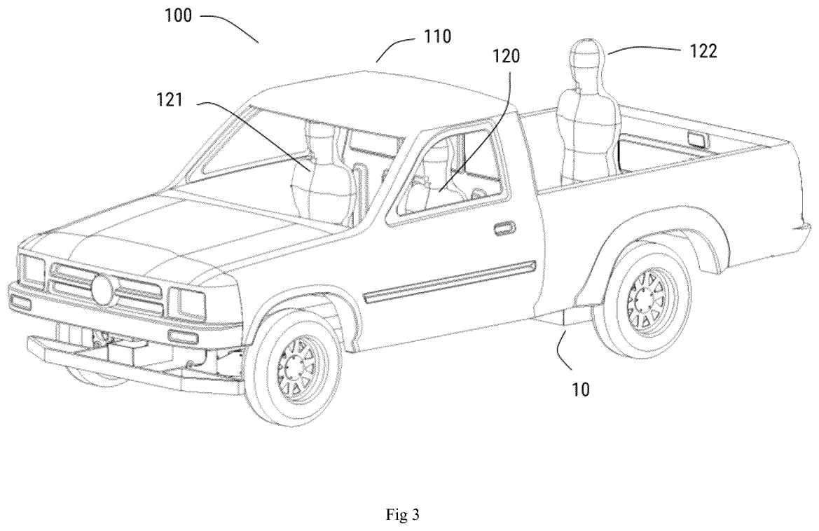

Referring to FIG. 3, a target 100 is shown which incorporates chassis 10 of FIG. 1. A target body 110 which has the appearance of a pick-up truck or a utility vehicle is mounted to the chassis 10 to thereby simulate the appearance of a motor vehicle. The target body is a mock-up of a vehicle body. It is formed from lightweight plastic material. This reduces the overall weight of the target. In addition, any bullets which strike the body will pass straight through and leave only a small puncture hole which is quite in obtrusive. The vehicle body is a sacrificial component which will withstand being struck many times by bullets before it requires replacement. It is estimated that the combined weight of the chassis and vehicle body is approximately 805 kg compared to the real vehicle which it represents which would weigh more than twice this weight.

The target 100 includes representations of vehicle occupants, being the driver and a passenger, in the form of human shaped hollow plastic mannequins 120, 121. Another occupant is shown located in the cargo tray of the vehicle. Any of all of the mannequins may be fitted with acoustic sensors. These act as a hit detection system to enable feedback to shooters as to the accuracy of their shots.

Trainees may be taught that the best way to disable a hostile or enemy vehicle using a firearm is to aim at the driver or the engine block. So, similarly, another hollow plastic chamber (not visible) is mounted in the front region of the vehicle to simulate the size, shape and location of what would be the engine block of the vehicle. Again, this plastic vessel is fitted with acoustic sensors to enable hit detection.

As an alternative to acoustic sensors associated with plastic mannequins or chambers, the hit detection system may be in the form of a 3D LOMAH (location of miss and hit) system. This would include a microphone array either in the form of a) a small array of microphones arranged around the occupant mannequin or engine block region or b) a larger array arranged around the perimeter of the vehicle.

The outputs of the hit detection sensors can be relayed to the trainee participants, or their trainer, via the on-board communication system of the chassis to enable real time feedback to trainees of the accuracy of their shots.

Target 100 is also fitted with heating elements in the region of where the radiator grille of the vehicle would be located, and also in the region of the engine block. This enables the target to exhibit a heat signature which mimics that of a real vehicle. This feature can be used when training personnel in engaging vehicles at night, using night sight enabled weaponry.

In other embodiments the target body may be in the shape of a sedan, SUV, minivan, wheeled armored vehicle or truck. All these vehicle types share the same propulsion and steering principle and can be effectively represented by an armored chassis carrying a lightweight body.

Chassis 10 can also be used in targets which simulate the appearance of tracked vehicles such as tracked armored vehicles, infantry fighting vehicles and tanks. The real vehicles have a different propulsion type but can still be simulated by chassis 10 which provides considerable weight savings. Side panels can be added to hide the wheels and present the appearance of tracked propulsion.

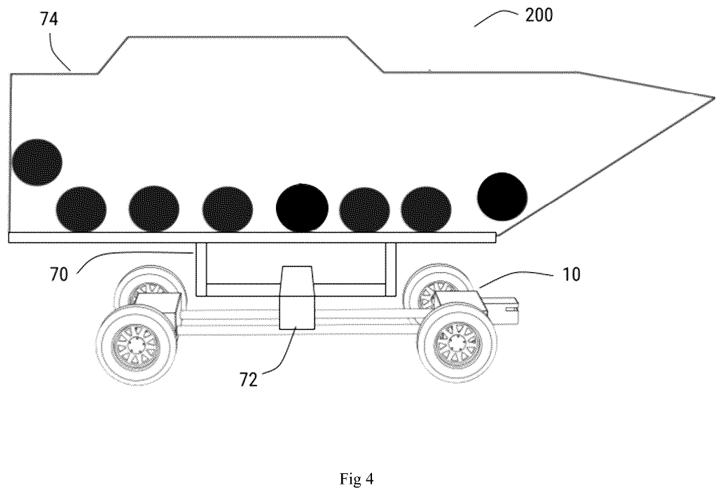

Referring to FIG. 4, chassis 10 is shown in an alternative implementation of a target 200 in which a standard SAT (Stationary Armour Target) lifter 72 is put on top of the chassis 10. A representation of a military vehicle 74, is raised up above the chassis 10 using support structures 70.

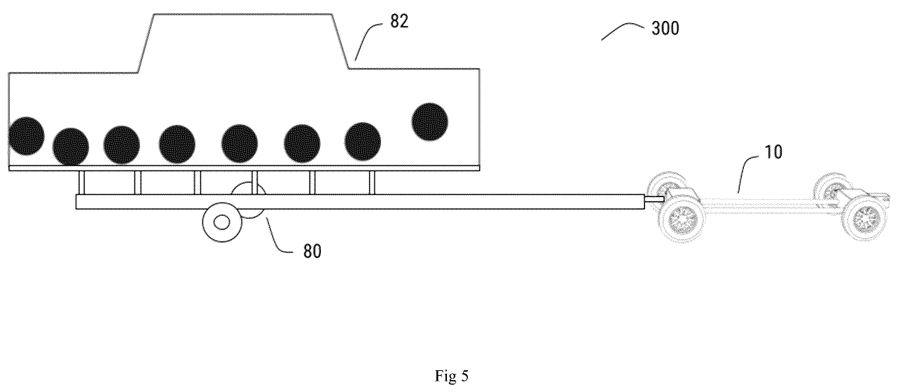

Referring to FIG. 5, in another implementation 300, the chassis 10 tows a trailer 80 which carries a representation of a tank 82.

In the configurations shown in FIGS. 4 and 5 the low height of the chassis 10 allows it to be completely hidden behind low protection berms when used in training exercises with high calibre ammunition. The long wheelbase of the chassis 10 provides good stability in these configurations, especially at high speed.

It can be seen that embodiments of the invention provide at least one or more of the following advantages:

The target chassis is both well-armored and lightweight.

The target chassis has low height which is desirable when operated behind protective berms.

The target chassis has a low center of mass which is desirable for vehicle stability.

The target chassis can be used to represent a full-sized human vehicle, including wheel diameter, wheelbase and track width, but the actual working parts are relatively small, thus reducing weight and cost to fabricate and maintain the target. This is because, unlike common civilian and military vehicles, it has no payload (i.e., occupants or cargo) which needs to be protected.

Ackermann steering realistically simulates a motor vehicle.

Any reference to prior art contained herein is not to be taken as an admission that the information is common general knowledge, unless otherwise indicated.

Finally, it is to be appreciated that various alterations or additions may be made to the parts previously described without departing from the spirit or ambit of the present invention.

1. A target chassis for a target for use in training personnel in engaging vehicles with munitions including:
a front armored enclosure;
a rear armored enclosure which is spaced away from the front armored enclosure; and
a set of front wheels is associated with the front armored enclosure, and a set of rear wheels is associated with the rear armored enclosure.

2. The target chassis according to claim 1 wherein the armored enclosures are maintained in a fixed spaced apart relationship by way of an arrangement of beams.

3. The target chassis according to claim 2 wherein the arrangement of beams includes two hollow cylindrical beams.

4. The target chassis according to claim 1, further including a set of rear suspension springs which are associated with the rear wheels, and the rear suspension springs are located inside the rear armored enclosure.

5. The target chassis according to claim 1, further including a set of rear dampers which are associated with the rear wheels, and the rear dampers are located inside the rear armored enclosure.

6. The target chassis according to claim 1, further including a set of front suspension springs which are associated with the front wheels, and the front suspension springs are located inside the front armored enclosure.

7. The target chassis according to claim 1, further including a set of front dampers which are associated with the front wheels, and the front dampers are located inside the front armored enclosure.

8. The target chassis according to claim 1, wherein the rear wheels are driven.

9. The target chassis according to claim 1, wherein the front wheels are driven.

10. The target chassis according to claim 8 further including one or more electric motors to drive at least two of the wheels of the chassis.

11. The target chassis according to claim 10 wherein an electric motor is associated with each driven wheel.

12. The target chassis according to claim 10 wherein the motors are located inside the armored enclosure with which the driven wheels are associated.

13. The target chassis according to claim 1, including a battery pack which is located in the rear armored enclosure.

14. The target chassis according to claim 1, including a battery pack which is located in the front armored enclosure.

15. The target chassis according to claim 1, further including a steering mechanism to enable the target to be steered.

16. The target chassis according to claim 15 wherein the steering mechanism is an Ackermann steering mechanism.

17. A target including:
a chassis comprising;
a front armored enclosure;
a rear armored enclosure which is spaced away from the front armored enclosure; and
a set of front wheels is associated with the front armored enclosure, and a set of rear wheels is associated with the rear armored enclosure; and
a target body mounted to the chassis, the target body having an outer appearance to simulate the appearance of a motor vehicle.

18. The target according to claim 17 wherein the target body includes at least one representation of an occupant of the vehicle.

19. The target according to claim 17 further including at least one bullet detection system.

20. The target according to claim 19 wherein the at least one bullet detection system is arranged to detect bullets striking the at least one representation of an occupant.

21. The target according to claim 19 wherein the at least one bullet detection system is arranged to detect a hit in the region of the expected location of the engine of the simulated vehicle.

22. The target according to claim 19 wherein the at least one bullet detection system is arranged to detect near misses of either the representations of the occupants or the expected location of the engine of the simulated vehicle.

23. The target according to claim 17 which further includes at least one heating device to simulate a thermal signature of a motor vehicle.
